(19) United States
(12) Patent Application Publication
(10) Pub. No.: US 2025/0101596 A1
(43) Pub. Date: Mar. 27, 2025

(54) METHODS OF PROTECTING A SURFACE OF A NI-BASED ALLOY

(71) Applicant: General Electric Company, Schenectady, NY (US)

(72) Inventors: Anantharaman Mahalingam, Bengaluru (IN); Srinivasan Swaminathan, Bengaluru (IN)

(21) Appl. No.: 18/529,480

(22) Filed: Dec. 5, 2023

(30) Foreign Application Priority Data
Sep. 25, 2023 (IN) 202311064236

(51) Int. Cl. C23C 24/04; C22C 19/05; C22C 19/07; C22F 1/10

(52) U.S. Cl. CPC C23C 24/04; C22C 19/055; C22C 19/07; C22F 1/10

(57) ABSTRACT

Methods of protecting a surface of a Ni-based alloy component are provided, along with the wear strip utilized and the repaired Ni-based alloy component. The method may include: spraying a plurality of particles to form a wear strip. The plurality of particles includes a mixture of Ni-based superalloy particles and Co-based superalloy particles. The plurality of particles is sprayed at a spray temperature that is less than a melting point of the Ni-based superalloy particles and less than a melting point of the Co-based superalloy particles. The wear strip may be attached onto a surface of the Ni-based alloy component, either during the spraying of the particles (when wear strip formed on the surface of the Ni-based alloy component) or after a standalone wear strip is formed.

### PRIORITY INFORMATION

The present application claims priority to Indian Patent Provisional Application Serial Number 202311064236 filed on Sep. 25, 2023.

### FIELD

The present disclosure relates generally to cold spray methods to form a wear strip, which may be suitable for protection of a Ni-based component.

### BACKGROUND

A gas turbine engine typically includes a turbomachinery core having a high-pressure compressor, combustor, and high-pressure turbine in serial flow relationship. The core is operable in a known manner to generate a primary gas flow. The high-pressure compressor includes annular arrays (“rows”) of stationary vanes that direct air entering the engine into downstream, rotating blades of the compressor. Collectively one row of compressor vanes and one row of compressor blades make up a “stage” of the compressor. Similarly, the high-pressure turbine includes annular rows of stationary nozzle vanes that direct the gases exiting the combustor into downstream, rotating blades of the turbine. Collectively one row of nozzle vanes and one row of turbine blades make up a “stage” of the turbine. Typically, both the compressor and turbine include a plurality of successive stages.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 shows an exemplary component having a wear strip formed by a cold spray process at a first portion of its surface;

FIG. 2 shows another exemplary component having a wear strip formed by the cold spray process at the first portion of its surface;

FIG. 3A is a close-up of an exemplary component having a wear strip thereon formed by a cold spray process;

FIG. 3B is a close-up of another exemplary component having a wear strip thereon formed by a cold spray process;

FIG. 4 shows a flow chart diagram of an exemplary method of protecting a surface of a Ni-based alloy component;

FIG. 5 shows a chart of the Coating Hardness for various exemplary wear strip chemistries according to the Examples of the present disclosure; and

FIG. 6 shows a chart of the Wear Rate for various exemplary wear strip chemistries according to the Examples of the present disclosure.

Repeat use of reference characters in the present specification and drawings is intended to represent the same or analogous features or elements of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

In the present disclosure, when a layer is being described as “on” or “over” another layer or substrate, it is to be understood that the layers can either be directly contacting each other or have another layer or feature between the layers, unless expressly stated to the contrary. Thus, these terms are simply describing the relative position of the layers to each other and do not necessarily mean “on top of” since the relative position above or below depends upon the orientation of the device to the viewer.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

Gas turbine engines, particularly aircraft engines, require a high degree of periodic maintenance. For example, engine components may exhibit wear during operation and often require repairs to restore their original dimensions and geometry. More specifically, engine components undergo wear during service due to rubbing with adjacent surfaces. Thermal spray coating repairs are often performed on engine components for dimensional build-up. However, the resulting repair material has debited properties due to oxidation, porosity, or both as part of thermal spray processes. In particularly damaged components, such as those formed from nickel-based (Ni-based) superalloys, thermal spray coating processes result in a higher coating porosity and requires surface preparation prior to forming the thermally sprayed coating for dimensional buildup. As such, a need exists for improved protection processes.

Methods are generally provided for protecting a surface of a Ni-based alloy component, such as a Ni-based superalloy component. For example, a wear strip may be formed on a desired location(s) where the component may be subject to wear during use. The component may be a new component or a used component that is being serviced. The wear strip may be formed using cold spray coating techniques to form the wear strip on the surface (e.g., formed directly on the surface) of the Ni-based alloy component in the desired location, while leaving other locations free from any wear strip. Alternatively, the wear strip may be formed separately and then attached to the surface of the Ni-based alloy component in the desired location, while leaving other locations free from any wear strip. The attachment may be by bonding (e.g., adhered) or by a mechanical attachment (e.g., bolted, pinned, screwed, etc.), such that the wear strip may be attached to components that experienced wear and tear during operation.

In particular non-limiting embodiments, when the wear strip may be formed on components in need of repair may show wear and tear that require build-up of material to replenish the original component material, the wear strip may build up as replacement material in a worn portion of the component, as well as a sacrificial area serving to further protect the component's surface (if desired). In such an embodiment, the cold spray coating techniques may be utilized to repair the Ni-based alloy component to its original shape, with additional build-up to further protect the component's surface. As such, cold spray based processes as contemplated herein may reduce scrap. Further still, cold spray based process as contemplated herein may salvage damaged engine components for future use. Although other components or articles may be contemplated by this disclosure, the remainder of this disclosure refers to components of an engine, such as a gas turbine engine.

In one embodiment, the wear strip formation process may be performed via a cold spray process that requires less heat input during the wear strip formation than alternative deposition methods, which also leads to a wear strip with less wrought microstructure. The wear strip formation process may form a wear strip with better fatigue strength, better wear resistance, tailored hardness, or a combination of these properties. Thus, the protected component may have longer time on wing, longer life limits on the hardware, reduction in spares and maintenance costs, or a combination thereof.

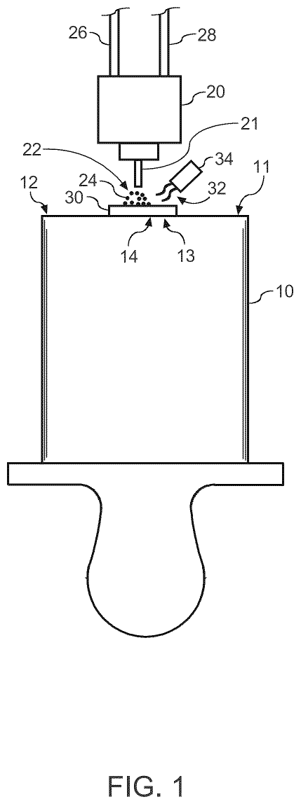

Referring to FIG. 1, an exemplary component 10 is shown in the form of an airfoil (e.g., of a turbine blade) of a turbine engine. However, it is to be understood that the component 10 is not limited to any particular shape or component and may be any suitable alloy component. In one embodiment, the component 10 is formed from a metal or a metal alloy. Examples include metals such as nickel, cobalt, titanium, aluminum, zirconium, and copper. Examples of metal alloys include nickel-base alloys, cobalt-base alloys, titanium-base alloys, iron-base alloys, steels, stainless steels, and aluminum-base alloys. As discussed in greater detail below, the component 10 may be formed of a Ni-based alloy component (i.e., a Ni-based alloy component).

Referring again to FIG. 1, the component 10 (e.g., a Ni-based alloy component) has a surface 12 that includes a first portion 14 that may be subject to normal wear during use, with the first portion 14 shown as the tip of the airfoil in this particular example.

As shown in FIG. 1, a spray gun 20 is shown spraying a stream 22 of particles 24 onto the first portion 14 of the surface 12 of the component 10. For example, the spray gun 20 may be a cold spray gun configured for use in a cold spray method. For example, cold spray methods may use a spray gun 20 that receives a high-pressure gas and a feedstock of particles 24, such as through the respective feed tubes 26, 28. For example, the high-pressure gas may be an inert gas that does not chemically react with the particles 24 or the component 10, including but not limited to argon, helium, nitrogen, air, etc.

During cold spraying, the powder granules are introduced at a high-pressure into the gas stream in the spray gun 20 and emitted from a nozzle 21. The particles 24 are accelerated to a high velocity in the gas stream that may reach a supersonic velocity. In particular embodiments, the particles 24 may have a flow function value that is 10 or less such that the particles 24 flow easily from the nozzle 21 of the spray gun 20.

Although referred to as a cold stream process, the gas stream may be heated, but to a sprayed temperature that is less than the melting point of the particles 24 to minimize in-flight oxidation and phase changes in the deposited material. For example, the particles 24 may be sprayed at a temperature of 500° C. to 1100° C. (e.g., 650° C. to 1100° C.). In one embodiment, the particles 24 may be sprayed at a relatively low temperature (e.g., 500° C. to 800° C., such as 650° C. to 800° C.). In other embodiments, the particles 24 may be sprayed at higher temperatures, but still below the melting point of the particle material (e.g., 800° C. to 1100° C., such as 800° C. to 950° C.). As a result of the relatively low deposition temperatures (i.e., below the melting point of the particle material) and very high velocities, cold spray processes offer the potential for depositing well-adhering, mechanically/metallurgically bonded, dense, hard and wear-resistant wear strips whose purity depends primarily on the purity of the feedstock powder used.

The particles 24 impact the first portion 14 of the surface 12 of the component 10 at a high velocity. The kinetic energy of the particles 24 causes the powder granules of the particles 24 to deform and flatten on impact with the component 10. The flattening promotes a metallurgical, mechanical, or combination of metallurgical and mechanical bond with the surface 12 and results in a deposit on the surface 12 (e.g., within the first portion 14). One advantage of cold spraying methods is the negligible to nil phase change or oxidation of particles 24 during flight and high adhesion strength of the deposited, deformed particles 24.

Changing some characteristics of the feedstock microstructure, morphology, or both to effect reduction of particle strength or hardness provides a softer particle feedstock be fed to the spray apparatus, allowing a softer material to impact and deform at the surface 12 and thus forming a dense, high quality deposit. Some embodiments of the disclosed method include a heat-treatment of the feedstock material that changes the material structure and property, making the feedstock amenable for cold-spraying. The disclosed method is different from an in-situ or inside-the-spray gun heat-treatment of the feedstock material during or just before spraying out the feedstock. The feedstock material used herein receives its heat-treatment and thus changes at least one of its microstructure, morphology, or strength/hardness, even before introduction into the cold spray apparatus. Further, the heat-treatment that is received by the feedstock material in this application is different than what can be applied inside a spray gun apparatus.

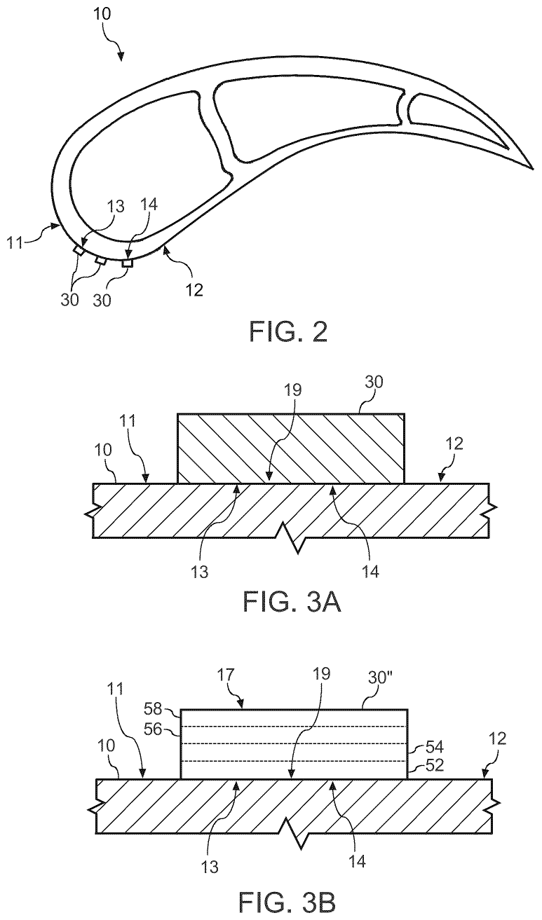

Upon deposition, the particles 24 form a wear strip 30 on the first portion 14 on the surface 12 of the component 10, as shown in FIG. 2. For example, the wear strip 30 may be formed up to a thickness of 6 mm, such as 1.5 mm to 6 mm) on the first portion 14. In certain embodiments, the wear strip 30 may have a thickness of 2.5 mm to 5 mm on the first portion 14 (e.g., 3.0 mm to 5 mm). Thus, the wear strip 30 defines a protected portion 13 on the first portion 14 of the surface 12 (covered by the wear strip 30), leaving an exposed portion 11.

As stated above, the component 10 may have an untreated surface 12 on the first portion 14 prior to the application of the wear strip 30. That is, the wear strip 30 (FIG. 2) may be applied directly to the untreated surface 12 without any pretreatment of the first portion 14, such as cleaning, degreasing, roughening (e.g., via grit blasting), or the like. Thus, the time, expense, and added complication of pretreatment methods may be avoided by applying the wear strip 30 directly onto the untreated surface 12 of the first portion 14.

Alternatively, the component 10 may be prepared prior to application of the wear strip 30. Preparing the component 10 for the application of the wear strip 30 via cold spray may include cleaning or degreasing the surface 12, and in particular the first portion 14. In one embodiment, a prepared region of the surface 12 is formed by removing the existing material or layer such as an oxide layer for example, from the surface 12 of the component 10 so that the wear strip is formed directly on the material of the component 10 so as to bond directly to the component 10.

The particles 24 may include a metal or a metal alloy, such as, for example, metals, refractory metals, alloys, or composite materials in powder form. In one embodiment, the particles 24 have a composition that is compatible with the material of the component 10, such as having a composition that is substantially identically to the material of the component 10 (as formed). However, the particles 24 may have a composition that is different than that of the material of the component 10 in other embodiments. With respect to the drawings, it should be noted that the cross-hatching in FIG. 2, as well as FIGS. 3A and 3B, are for illustrative purposes and that it will be understood that there may not be a transition line and the materials may be the same (or different) materials.

In one particular embodiment, the particles 24 are a mixture of Ni-based superalloy particles and Co-based superalloy particles. In one particular non-limiting embodiment, the mixture includes a majority (by weight) of the Co-based superalloy particles (i.e., greater than 50% by weight of the Co-based superalloy particles). For example, the mixture includes, in one embodiment, 55% by weight to 95% of the Co-based superalloy particles and 45% by weight to 5% of the Ni-based superalloy particles, such as 60% by weight to 90% of the Co-based superalloy particles and 40% by weight to 10% of the Ni-based superalloy particles. In one particular embodiment, the mixture includes 75% by weight to 85% of the Co-based superalloy particles and 25% by weight to 15% of the Ni-based superalloy particles.

The Co-based superalloy added to the Ni-based superalloy particles increases the strength of the wear strip 30, when compared to a wear strip formed of a Ni-based superalloy. By including the Co-based superalloy particles as a majority, by weight, the strength of the wear strip 30 may be increased to a desired strength and hardness.

Particularly suitable Co-based superalloys are commercially available under the trade name Tribaloy® (Kennametal Stellite Inc.). A non-limiting example of a cobalt-base alloy is Tribaloy® T-400 (Kennametal Stellite Inc.) having a composition that includes, in weight percent, at least 55.5% cobalt, less than 0.08% carbon (e.g., 0.001% to 0.08%), 8% to 9% chromium (e.g., 8.25% to 8.75%), less than 1.5% iron (e.g., 0.001% to 1.5%), 27.5% to 31% molybdenum (e.g., 28% to 30%), less than 1.5% nickel (e.g., 0.001% to 1.5%), 2.5% to 3% silicon (e.g., 2.75% to 2.85%), and less than 1.0% of other elements. Other examples of cobalt-base alloys may include, but are not limited to, Tribaloy® T-400 Cobalt Alloy, Tribaloy® T-800, Tribaloy® T-400C Cobalt Alloy, Tribaloy® T-700 Nickel Alloy, Tribaloy® 745, Tribaloy® T-401 Cobalt Alloy, etc.

In non-limiting examples where the composition of the particles 24 and the composition of the component 10 are different, the Ni-based superalloy particles are also included in the mixture such that the wear strip has a closer coefficient of thermal expansion (CTE) match to the Ni-based superalloy of the component 10. In particular embodiments, the Ni-based superalloy particles may include a Ni-based superalloy that is substantially identical in composition to the Ni-based alloy of the Ni-based alloy component 10 as originally formed. For example, the Ni-based superalloy particles may include a Ni-based superalloy such as those described below with respect to the material of the component 10 (e.g., under the tradename INCONEL® or RENE®). While different component Ni-based superalloy particles are encompassed by this disclosure, the Ni-based superalloy particles may have a nickel-base alloy with a composition, in weight percent, from 50 to 55 percent nickel, from 17 to 21 percent chromium, from 4.75 to 5.50 percent niobium, from 2.8 to 3.3 percent molybdenum, from 0.65 to 1.15 percent titanium, from 0.20 to 0.80 percent aluminum, 1.0 percent maximum cobalt, and balance iron (e.g., INCONEL® 718). Small amounts of other elements such as carbon, manganese, silicon, phosphorus, sulfur, boron, copper, lead, bismuth, and selenium may also be present.

Referring to FIG. 3A, the mixture of Ni-based superalloy particles and Co-based superalloy particles may be tailored through the cold spray method to form a wear strip 30′ having a desired composition of individual constituents therein. For example, in one embodiment, a relatively consistent (in terms of composition) wear strip 30′ may be formed. For example, the wear strip 30′ may include, by way of non-limiting example, up to 80% by weight of the Ni-based superalloy and a balance of the Co-based superalloy. Without wishing to be bound by any particular theory, it is believed that the composition of the wear strip 30′ may have a higher Ni wt % than in the particles 24 due to different deposition efficiency of the individual Ni-based superalloy particles and Co-based superalloy particles. By way of non-limiting example, the Ni-based superalloy particles may have a higher deposition efficiency that results in more wt % of the Ni-based superalloy being retained in the wear strip 30′ compared to the wt % of the Co-based superalloy in the particles 24. For example, a wear strip 30′ may have a composition that is 80% by weight of the Ni-based superalloy and 20% by weight of the Co-based superalloy from the deposition of a mixture of particles 24 that is 40% by weight Ni-based superalloy particles and 60% by weight Co-based superalloy particles.

Referring to FIG. 3B, the mixture of Ni-based superalloy particles and Co-based superalloy particles has varying relative amounts of Ni-based superalloy particles and Co-based superalloy particles during the cold spray method such that a graded wear strip is formed in the wear strip 30″. Thus, the cold spray methods may be utilized to form a wear strip 30″ that has a wear strip composition with a graded wear strip therein. For example, the wear strip 30″ may include an innermost layer 52 adjacent to the surface 12 and an outermost layer 58 opposite of the surface 12. Any suitable number of intermediate layers (shown as a first intermediate layer 54 and a second intermediate layer 56) may be positioned between the innermost layer 52 and the outermost layer 58. Each of these layers may have varying relative compositions of the Ni-based superalloy particles and the Co-based superalloy particles. For example, in one embodiment, the innermost layer 52 may have a relatively high Ni-based superalloy concentration compared to the outermost layer 58 such that the wear strip 30″ has a coefficient of thermal expansion (CTE) that is closer to that of the component 10 at the surface 12. Alternatively, the outermost layer 58 may have a relatively high Co-based superalloy concentration compared to the innermost layer 52 such that the wear strip 30″ has an increased hardness at its surface 17 opposite of the surface 12.

For example, the wear strip 30″ may transition in composition from a relatively high concentration of Ni-based superalloy at the innermost layer 52 to a relatively low concentration of Ni-based superalloy at the outermost layer 58, and vice versa from a relatively low concentration of Co-based superalloy at the innermost layer 52 to a relatively high concentration of Co-based superalloy at the outermost layer 58. The intermediate layers 54, 56, etc. may transition the composition from the innermost layer 52 to the outermost layer 58, such as via a graded transition from the that is stepped such that the change is non-linear or via a continuous transition such that the relative concentrations of Ni-based superalloy and Co-based superalloy constantly change. Further still, while the layers illustrated in FIG. 3B are linear for ease of illustration it will be understood that they may alternatively follow the profile of the defect 16 of the first portion 14 or have an alternative shape, profile, or form.

In one embodiment, multiple spray guns may be utilized to form such a changing wear strip composition, which at least one spray gun dedicated to the Ni-based superalloy particles and at least another spray gun dedicated to the Co-based superalloy particles. Alternatively, the mixture may be intermittently changed in composition during the cold spray deposition process to form a graded wear strip. Alternatively, the mixture may be intermittently or continuously changed in composition during the cold spray deposition process to form a gradient through the wear strip.

In particular non-limiting embodiments, the wear strip may be heat treated to further enhance the wear resistance and strength of the wear strip. Heat treatment of the wear strip can further enhance mechanical properties of the wear strip applied via cold spray techniques. While it will be understood that heat treating can be applied to any of the previously described wear strips it will also be understood that such heat treating is optional. The remainder of the disclosure will only discuss the wear strip 30 and the optional heat treating. In a further non-limiting example, the cold sprayed wear strip 30 may be heated concurrently during the cold spray process in order to potentially reduce or eliminate post-spray heat treatments. For example, referring back to FIG. 1, thermal energy 32 may be directed at the surface 12 using a heat gun 34 (or other heating device) during the wear strip formation process. In one embodiment, the wear strip 30 is heated to a treatment temperature of 250° C. to 1000° C. (e.g., 400° C. to 500° C.) during the cold spraying process.

However, in other embodiments, a post spraying heat treatment may be performed to heat the applied wear strip 30. For example, thermal energy may be directed to the wear strip 30 after its formation (e.g., using a heat gun, a hot isostatic press, or other heating device). Alternatively, the component 10 may be placed in an oven and heated for heat treatment of the wear strip 30. In one embodiment, the wear strip 30 is heated to a treatment temperature of 900° C. to 1300° C. (e.g., 1000° C. to 1200° C.) after its formation by the cold spraying process. Such a heat treatment may be performed for a period of at least 30 minutes, such as 30 minutes to 5 hours (e.g., 1 hour to 4 hours).

In one embodiment, the wear strip 30 is a highly dense that may lead to an increase in hardness and wear resistance for the first portion 14 of the component 10. For example, the porosity of the wear strip 30 may be 5% or less (e.g., 0.1% to 5%) upon heat treatment of the as-deposited wear strip. The wear strip 30 formed may have an increased wear resistance compared to the original Ni-based alloy component. Without wishing to be bound by any particular theory, it is believed that the enhanced mechanical property of the wear strip post heat treatment was due to the formation of a Gamma prime phase and diffusion bond at an interface 19 between the surface 12 and the wear strip 30 (e.g., as shown in FIGS. 3A and 3B). The heat treatment may also close any delamination at the interface of the wear strip 30 and may form a diffusion bond with the underlying layers/surfaces.

In one embodiment, the mixture of the cobalt-base alloy particles and nickel-base alloy particles of the mixture have average particle size of 10 μm to 40 μm (e.g., 10 μm to 30 μm). These particle sizes are sufficiently large to be utilized in the cold spray process, while being sufficiently small to form grains within the deposited wear strip 30.

As discussed previously, in one embodiment of the cold spray method presented herein, the mixture does not melt at the time of cold spraying. In one embodiment, the melting point of the mixture is above the temperature experienced by the mixture during cold spraying. In a further embodiment, the temperature experienced by the mixture is below 0.9 times the melting point of the mixture (i.e., of both the cobalt-base alloy particles and nickel-base alloy particles).

In one embodiment, a carrier gas is used for carrying the mixture for depositing, such as helium gas, nitrogen gas, atmospheric air, argon, or a mixture of any combination thereof. In one embodiment, the carrier gas temperature is in the range from 20° C. to 1200° C. (e.g., 500° C. to 1100° C., such as 650° C. to 1100° C.). In general, in the cold spray process, an impact critical velocity of the feedstock material is defined as below which the particle adhesion to the surface 12 is not useful for the intended application. The impact critical velocity of the feedstock material may depend on the particles 24 and the component's nature and properties. In one embodiment, operating the cold spray device used herein comprises accelerating the particles 24 to a velocity in the range from 500 m/s to 1100 m/s.

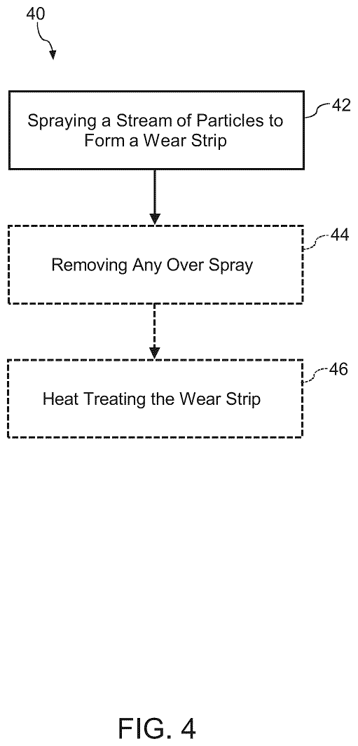

FIG. 4 shows an exemplary method 40 of forming a wear strip, which may be formed as a stand-alone strip to be attached to the surface of a component or may be formed directly on a surface of the component, and may include any of the description above. At 42, a stream of particles is sprayed onto a forming surface (e.g., a transfer surface or the surface of the component) to form a wear strip. At 44, any over spray of the particles is optionally removed from the surface, which is particularly applicable to the embodiments where the stream of particles is sprayed directly on the surface of the component. For example, the over-spray portion of the wear strip may be removed via machining (e.g., grinding), chemical etching, etc. At 46, the wear strip may optionally be heat treated, as discussed above. In particular, the wear strip may be heat treated on the component's surface to help bond thereto. Through this method 40, the wear strip (e.g., wear strip 30, 30′, 30″ of FIGS. 1, 2, 3A, 3B) may have a composition that is 5% by weight to 80% by weight of the Ni-based superalloy and 20% by weight to 95% by weight of the Co-based superalloy, such as 10% by weight to 60% by weight of the Ni-based superalloy and 40% by weight to 90% by weight of the Co-based superalloy (e.g., 15% by weight to 50% by weight of the Ni-based superalloy and 50% by weight to 85% by weight of the Co-based superalloy).

Referring again to FIG. 1, the component 10 is formed of a nickel-based alloy in certain embodiments as stated above. The component 10, the wear strip 30, or both may be formed of nickel-based superalloys. Exemplary nickle-based superalloys are commercially available under the trade names INCONEL® (Special Metals Corporation) or RENE® (Teledyne Industries, Inc. of Los Angeles, Calif). While different component materials are encompassed by this disclosure, the description below of the component utilizes nickel-base alloys as the component material as one particular embodiment. A non-limiting example of a nickel-base alloy is INCONEL® alloy 718 (Special Metals Corporation, Hartford, NY), having a composition, in weight percent, from 50 to 55 percent nickel, from 17 to 21 percent chromium, from 4.75 to 5.50 percent niobium, from 2.8 to 3.3 percent molybdenum, from 0.65 to 1.15 percent titanium, from 0.20 to 0.80 percent aluminum, 1.0 percent maximum cobalt, and balance iron. Small amounts of other elements such as carbon, manganese, silicon, phosphorus, sulfur, boron, copper, lead, bismuth, and selenium may also be present (all under 1% by weight).

Strengthened nickel-base alloys generally include precipitated phases, such as for example, Gamma prime (γ′), Gamma-double prime (γ″), and high-temperature precipitates such as, for example, carbides, oxides, borides, and nitride phases, either singularly or in combination, depending on the alloy composition and heat-treatments conditions of the alloy. In some embodiments, phases such as at least one of delta, sigma, eta, mu, or laves may also be present. The precipitate phases such as Gamma prime and Gamma-double prime in nickel base alloys are typically dissolved during solution heat-treatments, and re-precipitate during cooling from the solution temperature and during subsequent aging heat-treatments. The result is a distribution of at least one of gamma-prime or gamma-double prime secondary phases in a nickel-alloy matrix. High-temperature precipitates such as carbides, oxides, borides, and nitride phases may not typically dissolve during solution heat-treatments and may thus remain as precipitates even after solution heat-treatment of the alloys.

In typical precipitate hardened nickel alloys, the alloys are initially given a solution treatment (or, in the parlance of the art, the alloys are initially “solutioned” or “solutionized”), wherein the alloys are heated above the solvus temperature of the precipitates. The precipitates referred herein may be the ‘primary’, ‘secondary’, or ‘tertiary’ precipitates that form during different stages of temperature-treatments rather than the high temperature carbide, oxide, boride, or nitride phases that may be present even above the solvus temperatures of the primary/secondary/tertiary precipitates.

Generally, the alloys are quenched after solution treatment forming a supersaturated solid solution phase. In one embodiment, the matrix includes nickel-base gamma (γ) phase. The gamma-phase is a solid solution with a face-centered cubic (fcc) lattice and randomly distributed different species of atoms. In some alloys, where the high temperature precipitate phases are present, the supersaturated solid solution phases may still have the precipitates of those high temperature phases. In one embodiment, in a gamma-prime system like Rene 88® or Waspaloy® for example, the gamma prime may precipitate quickly even during quenching. Typically, alloys in the solutioned state, even where precipitation occurs during quenching, are significantly softer than alloys in the fully processed state, as noted below.

In the third step, the supersaturated solid solution phase is heated below the solvus temperature of the precipitates to produce a finely dispersed precipitate. For example, in a gamma-double prime system, the gamma-double prime phase may largely precipitate during the aging treatment thereby hardening and strengthening the alloy.

Thus, strengthened nickel-base alloys are typically processed by using designed solution heat-treatment methods that dissolve gamma-prime or gamma-double prime strengthening phases and then allow the optimum reprecipitation of these phases upon cooling from heat-treatment or after subsequent aging of the solutioned alloys. The cooling rate, and cooling path imposed on nickel-base alloy components, along with the aging temperature and times, and inherent properties of the particular compositions normally influence development of optimum properties in the nickel-base alloys.

Further aspects are provided by the subject matter of the following clauses:

A method comprising: spraying a plurality of particles to form a wear strip, wherein the plurality of particles comprises a mixture of Ni-based superalloy particles and Co-based superalloy particles, and wherein the plurality of particles is sprayed at a spray temperature that is less than a melting point of the Ni-based superalloy particles and less than a melting point of the Co-based superalloy particles.

The method of any preceding clause, further comprising: attaching the wear strip onto a surface of a Ni-based alloy component.

The method of any preceding clause, wherein the wear strip is formed directly on the surface of the Ni-based alloy component to be bonded thereon.

The method of any preceding clause, wherein the surface of the Ni-based alloy component is untreated when the plurality of particles is sprayed thereon.

The method of any preceding clause, wherein the wear strip is formed separately and attached to the surface of the Ni-based alloy component.

The method of any preceding clause, further comprising: heat treating the wear strip on the surface of the Ni-based alloy component, wherein heat treating the wear strip comprises heating the wear strip to 1000° C. or hotter for a period of at least 30 minutes, and wherein the wear strip has a porosity of 2% or less after heat treatment.

The method of any preceding clause, wherein the wear strip has a thickness of 1 mm to 6 mm on the surface of the Ni-based alloy component.

The method of any preceding clause, wherein the wear strip defines a ring.

The method of any preceding clause, wherein the mixture includes greater than 50% by weight of the Co-based superalloy particles.

The method of any preceding clause, wherein the Co-based superalloy particles comprise 55% by weight to 95% of the mixture and the Ni-based superalloy particles comprise 5% by weight to 45% of the mixture.

The method of any preceding clause, wherein the Ni-based superalloy particles comprise 10% by weight to 40% of the mixture, and wherein the Co-based superalloy particles comprise 60% by weight to 90% of the mixture.

The method of any preceding clause, wherein the wear strip has varying relative amounts of Ni-based superalloy particles and Co-based superalloy particles therein.

The method of any preceding clause, wherein the wear strip has a graded architecture through a thickness thereof.

The method of any preceding clause, wherein the wear strip is formed directly on the surface of the Ni-based alloy component to be bonded thereon, wherein the wear strip includes an inner amount of Ni-based superalloy particles at an interface with the Ni-based alloy component and an outer amount of Ni-based superalloy particles opposite the interface, wherein the inner amount of Ni-based superalloy particles is a greater weight percent than the outer amount of Ni-based superalloy particles.

The method of any preceding clause, wherein the wear strip is formed directly on the surface of the Ni-based alloy component to be bonded thereon, wherein the wear strip has an inner amount of Co-based superalloy particles at the surface of the Ni-based alloy component and an outer amount of Co-based superalloy particles opposite the surface of the Ni-based alloy component, wherein the inner amount of Co-based superalloy particles is a greater weight percent than the outer amount of Co-based superalloy particles.

The method of any preceding clause, wherein the Ni-based superalloy particles comprise a Ni-based superalloy comprising, in weight percent, 50% to 55% nickel, 17% to 21% chromium, 4.75% to 5.50% niobium, 2.8% to 3.3% molybdenum, 0.65% to 1.15% titanium, 0.20% to 0.80% aluminum, up to 1.0% cobalt, and a balance of iron.

The method of any preceding clause, wherein the Ni-based superalloy particles have an average size of 10 μm to 40 μm, and wherein the Co-based superalloy particles have an average size of 10 μm to 40 μm.

The method of any preceding clause, wherein the Co-based superalloy particles comprise a Co-based superalloy comprising, in weight percent, at least 55.5% cobalt, less than 0.08% carbon, 8% to 9% chromium, less than 1.5% iron, 27.5% to 31% molybdenum, less than 1.5% nickel, 2.5% to 3% silicon, less than 1.0% of other elements.

The method of any preceding clause, wherein the plurality of particles is carried by a high-pressure gas stream, wherein the high-pressure gas stream is heated to the spray temperature, wherein the spray temperature is 500° C. to 1100° C.

The method of any preceding clause, wherein the surface of the Ni-based alloy component is untreated when the plurality of particles is sprayed thereon. A Ni-based alloy component formed according to the method of any preceding clause.

A Ni-based alloy component, comprising: a wear strip formed via the method of any preceding clause over a surface of the Ni-based alloy component.

A Ni-based alloy component, comprising: a wear strip over a surface of the Ni-based alloy component, wherein the wear strip comprises a plurality of deformed particles therein, wherein the plurality of deformed particles comprises 5% by weight to 80% by weight of a Ni-based superalloy and 20% by weight to 95% by weight of a Co-based superalloy.

### EXAMPLES

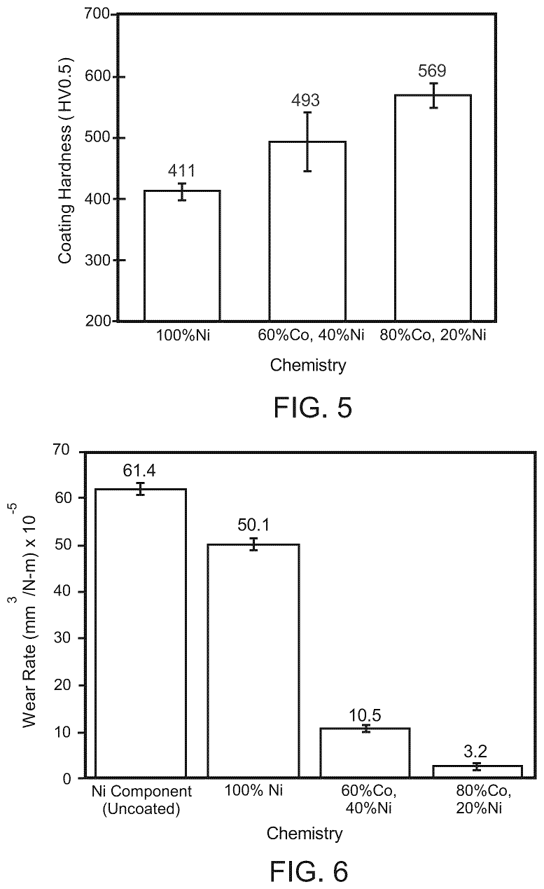

FIG. 5 shows the Coating Hardness (Hv) of exemplary wear strips formed from three different chemistries of particles 24. The particle chemistry labeled “100% Ni” refers to a wear strip formed by a cold spray method utilizing 100% by weight of the Ni-based superalloy particles available commercially under the tradename INCONEL® 718. The mixture chemistry labeled “60% Co, 40% Ni” refers to a wear strip formed by a cold spray method utilizing a mixture of 60% by weight of the Co-based superalloy particles available commercially under the tradename Tribaloy® T-400 and 40% by weight of the Ni-based superalloy particles available commercially under the tradename INCONEL® 718. The mixture chemistry labeled “80% Co, 20% Ni” refers to a wear strip formed by a cold spray method utilizing a mixture of 80% by weight of the Co-based superalloy particles available commercially under the tradename Tribaloy® T-400 and 20% by weight of the Ni-based superalloy particles available commercially under the tradename INCONEL® 718. As shown in FIG. 5, the Coating Hardness increases with the relative amount of the Co-based superalloy in the mixture utilized in the respective cold spray method.

FIG. 6 shows the Wear Rate (mm³/N−m×10⁻⁵) of three different Mixture Chemistries compared to an uncoated surface of a Ni component. The uncoated component is formed from 100% INCONEL® 718. The particle chemistry labeled “100% Ni” refers to a wear strip formed by a cold spray method utilizing 100% by weight of the Ni-based superalloy particles available commercially under the tradename INCONEL® 718. The mixture chemistry labeled “60% Co, 40% Ni” refers to a wear strip formed by a cold spray method utilizing a mixture of 60% by weight of the Co-based superalloy particles available commercially under the tradename Tribaloy® T-400 and 40% by weight of the Ni-based superalloy particles available commercially under the tradename INCONEL® 718. The mixture chemistry labeled “80% Co, 20% Ni” refers to a wear strip formed by a cold spray method utilizing a mixture of 80% by weight of the Co-based superalloy particles available commercially under the tradename Tribaloy® T-400 and 20% by weight of the Ni-based superalloy particles available commercially under the tradename INCONEL® 718. As shown in FIG. 6, the Wear Rate decreases significantly as the relative amount of the Co-based superalloy increases in the mixture utilized in the respective cold spray method.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method comprising:
spraying a plurality of particles to form a wear strip, wherein the plurality of particles comprises a mixture of Ni-based superalloy particles and Co-based superalloy particles, and wherein the plurality of particles is sprayed at a spray temperature that is less than a melting point of the Ni-based superalloy particles and less than a melting point of the Co-based superalloy particles.

2. The method of claim 1, further comprising:
attaching the wear strip onto a surface of a Ni-based alloy component.

3. The method of claim 2, wherein the wear strip is formed directly on the surface of the Ni-based alloy component to be bonded thereon.

4. The method of claim 3, wherein the surface of the Ni-based alloy component is untreated when the plurality of particles is sprayed thereon.

5. The method of claim 2, wherein the wear strip is formed separately and attached to the surface of the Ni-based alloy component.

6. The method of claim 2, further comprising:
heat treating the wear strip on the surface of the Ni-based alloy component, wherein heat treating the wear strip comprises heating the wear strip to 1000° C. or hotter for a period of at least 30 minutes, and wherein the wear strip has a porosity of 2% or less after heat treatment.

7. The method of claim 2, wherein the wear strip has a thickness of 1 mm to 6 mm on the surface of the Ni-based alloy component.

8. The method of claim 1, wherein the wear strip defines a ring.

9. The method of claim 1, wherein the mixture includes greater than 50% by weight of the Co-based superalloy particles.

10. The method of claim 1, wherein the Co-based superalloy particles comprise 55% by weight to 95% of the mixture and the Ni-based superalloy particles comprise 5% by weight to 45% of the mixture.

11. The method of claim 1, wherein the Ni-based superalloy particles comprise 10% by weight to 40% of the mixture, and wherein the Co-based superalloy particles comprise 60% by weight to 90% of the mixture.

12. The method of claim 1, wherein the wear strip has varying relative amounts of Ni-based superalloy particles and Co-based superalloy particles therein.

13. The method of claim 12, wherein the wear strip has a graded architecture through a thickness thereof.

14. The method of claim 12, wherein the wear strip is formed directly on the surface of the Ni-based alloy component to be bonded thereon, wherein the wear strip includes an inner amount of Ni-based superalloy particles at an interface with the Ni-based alloy component and an outer amount of Ni-based superalloy particles opposite the interface, wherein the inner amount of Ni-based superalloy particles is a greater weight percent than the outer amount of Ni-based superalloy particles.

15. The method of claim 12, wherein the wear strip is formed directly on the surface of the Ni-based alloy component to be bonded thereon, wherein the wear strip has an inner amount of Co-based superalloy particles at the surface of the Ni-based alloy component and an outer amount of Co-based superalloy particles opposite the surface of the Ni-based alloy component, wherein the inner amount of Co-based superalloy particles is a greater weight percent than the outer amount of Co-based superalloy particles.

16. The method of claim 1, wherein the Ni-based superalloy particles comprise a Ni-based superalloy comprising, in weight percent, 50% to 55% nickel, 17% to 21% chromium, 4.75% to 5.50% niobium, 2.8% to 3.3% molybdenum, 0.65% to 1.15% titanium, 0.20% to 0.80% aluminum, up to 1.0% cobalt, and a balance of iron.

17. The method of claim 1, wherein the Ni-based superalloy particles have an average size of 10 μm to 40 μm, and wherein the Co-based superalloy particles have an average size of 10 μm to 40 μm.

18. The method of claim 1, wherein the Co-based superalloy particles comprise a Co-based superalloy comprising, in weight percent, at least 55.5% cobalt, less than 0.08% carbon, 8% to 9% chromium, less than 1.5% iron, 27.5% to 31% molybdenum, less than 1.5% nickel, 2.5% to 3% silicon, less than 1.0% of other elements.

19. The method of claim 1, wherein the plurality of particles is carried by a high-pressure gas stream, wherein the high-pressure gas stream is heated to the spray temperature, wherein the spray temperature is 500° C. to 1100° C.

20. A Ni-based alloy component, comprising: a wear strip formed via the method of claim 1 over a surface of the Ni-based alloy component.
